(19) United States
(12) Patent Application Publication
(10) Pub. No.: US 2026/0304461 A1
(43) Pub. Date: Oct. 1, 2026

(54) PSFCH SIGNAL DETECTION METHOD AND DEVICE, STORAGE MEDIUM, AND ELECTRONIC DEVICE

(71) Applicant: SANECHIPS TECHNOLOGY CO., LTD., Nanshan District Shenzhen, Guangdong (CN)

(72) Inventors: Zhijun LONG, Shenzhen, Guangdong (CN); Junling ZHANG, Shenzhen, Guangdong (CN)

(21) Appl. No.: 18/993,091

(22) PCT Filed: Jun. 21, 2023
(86) PCT No.: PCT/CN2023/101715

§ 371 Date: Jan. 10, 2025

(30) Foreign Application Priority Data
Jul. 11, 2022 (CN) 202210808598.1

(51) Int. Cl. H04W 72/40; H04L 5/00; H04L 27/26

(52) U.S. Cl. CPC H04W 72/40; H04L 5/0053; H04L 27/2614

(57) ABSTRACT

The present application provides a PSFCH signal detection method and device, a storage medium, and an electronic device. The method includes: determining a sum of weighted powers of a received PSFCH signal and a local NACK sequence; determining a peak phase and a peak power based on the sum of weighted powers, determining a base power based on the sum of weighted powers and the peak power, and determining a ratio of the peak power to the base power; determining an output weight of the PSFCH signal based on the peak phase and the ratio, and setting an output state for the PSFCH signal; and detecting the PSFCH signal based on the output weight and the output state.

### CROSS-REFERENCE TO RELATED APPLICATIONS

This application claims priority to the patent application No. 202210808598.1 filed with the China Patent Office on Jul. 11, 2022, which is incorporated by reference hereby in its entirety.

### TECHNICAL FIELD

The present application relates to, but is not limited to, the field of communications.

### BACKGROUND

The 3GPP sidelink communication system is widely applied in Vehicle-to-everything (V2X) communications, and has been developed from LTE Sidelink to NR Sidelink now. An important development of NR Sidelink over LTE Sidelink is a hybrid automatic repeat request (HARQ) process supporting physical sidelink shared channel (PSSCH), in which HARQ information transmission and reception between terminals are implemented by adding a PSFCH to the NR Sidelink.

The 3GPP R16 NR protocol defines that a physical sidelink feedback channel (PSFCH) of Sidelink is used by a user equipment (UE) to receive the PSSCH channel and then feed back correct reception ACK or reception error NACK information to the sending UE for HARQ retransmission. There are two transmission methods: in a first method, a receiving UE transmits an NACK or ACK sequence to feed back reception error (NACK sequence) or correct reception (ACK sequence) information of a PSSCH to a sending UE; and in a second method, a receiving UE transmits a NACK sequence or does not transmit any information (a Not Active sequence, referred to as NA sequence for short) to feed back reception error (NACK sequence) or correct reception (NA sequence) information of a PSSCH to a sending UE. Both the receiving UE and the sending UE transmit and receive the PSFCH in one of the two methods through unified higher-layer signaling.

When the received signal has a relatively low signal noise ratio (SNR), that is, when an input signal of an amplifier has a relatively low power, the detection performance is degraded due to high randomness of a channel impulse response (CIR) peak after correlation between a local sequence and a received additive white Gaussian noise (AWGN). Especially when the second method is used for transmitting a PSFCH, since the NA sequence contains only AWGN, there is a higher probability of mistaking the transmitted NACK sequence as an NA sequence, or mistaking the NA sequence as an NACK sequence, under a low SNR.

For the problem of the high error detection probability of the PSFCH signal in the case of a relatively low SNR of the received signal in the existing art, no solution has been proposed yet.

### SUMMARY

The present application provides a PSFCH signal detection method and device, a storage medium, and an electronic device.

According to one aspect of the present application, there is provided a PSFCH signal detection method, including: determining a sum of weighted powers of a received PSFCH signal and a local NACK sequence; determining a peak phase and a peak power based on the sum of weighted powers, determining a base power based on the sum of weighted powers and the peak power, and determining a ratio of the peak power to the base power; determining an output weight of the PSFCH signal based on the peak phase and the ratio, and setting an output state for the PSFCH signal; and detecting the PSFCH signal based on the output weight and the output state.

According to another aspect of the present application, there is further provided a PSFCH signal detection device, including: a first determination module configured to determine a sum of weighted powers of a received PSFCH signal and a local NACK sequence; a second determination module configured to determine a peak phase and a peak power based on the sum of weighted powers, determine a base power based on the sum of weighted powers and the peak power, and determine a ratio of the peak power to the base power; a third determination module configured to determine an output weight of the PSFCH signal based on the peak phase and the ratio, and set an output state for the PSFCH signal; and a detection module configured to detect the PSFCH signal based on the output weight and the output state.

According to another aspect of the present application, there is further provided a computer-readable storage medium having a computer program stored thereon, wherein the computer program, when executed by a processor, causes the processor to implement operations of any method described herein.

According to another aspect of the present application, there is further provided an electronic device, including a memory and a processor, wherein the memory has a computer program stored thereon, and the processor is configured to execute the computer program to perform operations of any method described herein.

### BRIEF DESCRIPTION OF DRAWINGS

FIG. 1 is a hardware block diagram of a mobile terminal for implementing a PSFCH signal detection method of the present application;

FIG. 2 is a flowchart of a PSFCH signal detection method according to the present application;

FIG. 3 is a schematic diagram of a PSFCH reception detection system;

FIG. 4 is a schematic diagram of error detection performance verification for NACK and NA sequences;

FIG. 5 is a schematic diagram of a PSFCH detection system according to the present application;

FIG. 6 is a schematic diagram of error detection performance verification for NACK and NA sequences according to the present application; and

FIG. 7 is a block diagram of a PSFCH signal detection device according to the present application.

### DETAIL DESCRIPTION OF EMBODIMENTS

Implementations of the present application will be described in detail below with reference to the drawings in conjunction with the implementations.

It should be noted that terms “first”, “second”, and the like in the description, claims and drawings of the present application are used for the purpose of distinguishing similar objects instead of indicating a specific order or sequence.

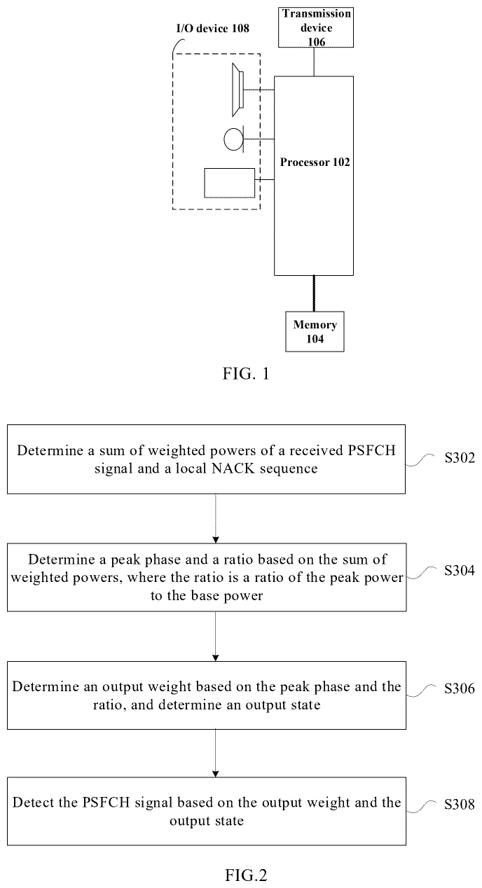

The method provided in the present application may be implemented in a mobile terminal, a computer terminal or any other computing apparatus. Taking the case of running on a mobile terminal as an example, FIG. 1 is a hardware block diagram of a mobile terminal for implementing a PSFCH signal detection method of the present application, and as shown in FIG. 1, the mobile terminal may include one or more processors 102 (merely one is shown in FIG. 1) (the processor 102 may include, but is not limited to, a microprocessor (MCU) or a programmable logic device like FPGA, or other processing devices) and a memory 104 configured to store data. The mobile terminal may further include a transmission device 106 for a communication function and an input/output (I/O) device 108. It will be understood by those ordinary skilled in the art that the structure shown in FIG. 1 is merely illustrative, and does not form any limitation to the structure of the above mobile terminal. For example, the mobile terminal may include more or fewer components than those shown in FIG. 1, or have a different configuration than that shown in FIG. 1.

The memory 104 may be configured to store a computer program, for example, an application software program or a module, such as a computer program corresponding to the PSFCH signal detection method of the present application, while the processor 102 may, by executing the computer program stored in the memory 104, perform various functional applications and PSFCH signal detection and processing, that is, implement the above method. The memory 104 may include a high-speed random access memory, and may further include a non-volatile memory, such as one or more magnetic storage devices, a flash, or any other non-volatile solid state memory. In some examples, the memory 104 may further include a memory remote to the processor 102, which may be connected to the mobile terminal via a network. Examples of the network include, but are not limited to, the Internet, intranets, local area networks, mobile communication networks, and combinations thereof.

The transmission device 106 is configured to receive or transmit data via a network. An example of the network may include a wireless network provided by a communication provider of the mobile terminal. In one example, the transmission device 106 includes a network interface controller (NIC) that may be connected to another network device through a base station to communicate with the Internet. In one example, the transmission device 106 may be a radio frequency (RF) module configured to communicate with the Internet wirelessly.

The present application provides a PSFCH signal detection method operating on the mobile terminal or network architecture as described above. FIG. 2 is a flowchart of a PSFCH signal detection method according to the present application. As shown in FIG. 2, the flow includes the following operations S302 to S308.

At operation S302, determining a sum of weighted powers of a received PSFCH signal and a local NACK sequence.

In one implementation, the sum of weighted powers may be determined in operation S302 by:
performing a dot product operation of a PSFCH frequency domain signal R(iRx, m) received at a receiving port iRx on a subcarrier m and a conjugate

$${x}_{N A C K}^{*} ( m )$$

of a local NACK sequence on the subcarrier m based on the subcarrier, performing invert fast Fourier transformation (IFFT) on point N_{IFFT}, and solving a modulus square for each IFFT result at a time point k and performing weighted summation based on a weight b_{iRx} of the receiving port iRx to obtain a sum of weighted powers CIR(k) at the time point k, which is expressed as:

$$CIR ( k ) = {\sum }_{iRx} {b}_{iRx} * {\vert {IFFT}_{{N}_{IFFT}} \{ R ( iRx , m ) * {x}_{NACK}^{*} ( m ) \} \vert}^{2} ;$$

where N_{IFFT} is an integer of power N of 2 greater than or equal to

$${N}_{sc}^{RB}$$

In the above equation, the receiving port iRx has a weight:

$${b}_{iRx} = \{ \begin{matrix}1. , {iRx}_{minG} = {min}_{iRx} \{ G ( iRx ) \} \\ \frac{G ( {iRx}_{minG} )}{G ( iRx )} , others\end{matrix} ,$$

where iRx_{minG} is a receiving port with the minimum gain, G(iRx) is a gain at the receiving port iRx determined through symbol l′−1,

$${N}_{sc}^{RB}$$

is a sixth preset value, k=0,1, . . . , N_{IFFT}−1, and m=0,1, . . . , N_{IFFT}−1. The sum of weighted powers CIR(k) is also denoted as a cross-correlation result of the received PSFCH signal R(iRx, m) and the local NACK sequence x_{NACK}(m), where

$${x}_{NACK}^{*} ( m )$$

is a conjugate of the local NACK sequence x_{NACK}(m) on the subcarrier m.

At operation S304, determining a peak phase and a peak power based on the sum of weighted powers, determining a base power based on the sum of weighted powers and the peak power, and determining a ratio of the peak power to the base power.

In one implementation, the operation S304 may include:
searching for a position maximum value within a time point k range from the sum of weighted powers CIR(k), and determining the position maximum value as the peak phase, where k=0,1, . . . , N_{IFFT}−1, and

$${N}_{IFFT} \geq max ( 32 , {N}_{sc}^{RB} ) ,$$

$${N}_{SC}^{R B}$$

is a sixth preset value;
searching for a power maximum value within a time point k range from the sum of weighted powers CIR(k), and determining the power maximum value as the peak power;
determining the base power based on the sum of weighted powers and the peak power by:

$${P}_{s e q} = \frac{{Σ}_{k} CIR ( k ) - {P}_{NACK}}{{N}_{IFFT} - 1} ;$$

and
determining the ratio of the peak power to the base power by:

$${Det}_{P} = \frac{{P}_{NACK}}{{P}_{s e q}} ;$$

where CIR(k) is the sum of weighted powers, Ph_{NACK} is the peak phase, P_{NACK} is the peak power, P_{seq} is the base power, and Det_{P} is the ratio.

At operation S306, determining an output weight of the PSFCH signal based on the peak phase and the ratio, and setting (determining) an output state for the PSFCH signal.

At operation S308, detecting the PSFCH signal based on the output weight and the output state.

In one implementation, the operation S306 may include operations S1 and S2.

At operation S1, under the condition that higher-layer signaling indicates that the PSFCH signal is an NACK sequence or an NA sequence, determining the output weight of the PSFCH signal based on the peak phase, the ratio, a phase threshold of the NA sequence and a phase threshold of the NACK sequence, and setting the output state for the PSFCH signal.

At operation S2, under the condition that higher-layer signaling indicates that the PSFCH signal is an NACK sequence or an ACK sequence, determining the output weight based on the peak phase, the ratio, a power threshold of the NACK sequence, a power threshold of the NA sequence, and a phase threshold of the NACK sequence, and setting the output state for the PSFCH signal.

The operation S1 may include: initializing the output weight flag to an initial value, and initializing the output state flag1 to 0; under the condition that an absolute value abs(Ph_{NACK}) of the peak phase is greater than or equal to the phase threshold Th_{Ph,NA} of the NA sequence, determining the output weight flag of the PSFCH signal by: flag=−b*c2/c1, while the output state flag1 remains unchanged; and under the condition that the ratio is less than or equal to the power threshold of the NA sequence, i.e., Detₚ≤Th_{P,NA}, setting the output state flag to 1, and determining the output weight flag of the PSFCH signal by: flag=−b*c2*c1;
where b is a first preset value,

$$c 1 = \frac{{Th}_{P , NA}}{{Det}_{P}} , c 2 = \frac{{Ph}_{NACK}}{{Th}_{Ph}} ,$$

Th_{Ph,NA} is the phase threshold of the NA sequence, Th_{P,NA} is the power threshold of the NA sequence, Ph_{NACK} is the peak phase, Det_{P} is the ratio, and Th_{Ph} is the phase threshold of the NACK sequence.

The operation S2 may include: under the condition that an absolute value abs(Ph_{NACK}) of the peak phase is less than the phase threshold Th_{Ph} of the NACK sequence, initializing the output weight flag, and initializing the output state flag1 to 0; and
keeping the output state flag1 unchanged if the ratio is greater than the power threshold of the NACK sequence, i.e., Det_{P}>Th_{P}; where under the condition that the output weight flag is equal to an initial value, if an absolute value abs(Ph_{NACK}) of the peak phase is less than the phase threshold Th_{Ph,NA} of the NA sequence, then flag=b0*c2*c0; and if the absolute value abs(Ph_{NACK}) of the peak phase is greater than or equal to the phase threshold Th_{Ph,NA} of the NA sequence, then flag=b*c2*c0; under the condition that flag is not equal to an initial value, if an absolute value abs(Ph_{NACK}) of the peak phase is less than the phase threshold Th_{Ph,NA} of the NA sequence, then flag=flag+b0*c2*c0; and if the absolute value abs(Ph_{NACK}) of the peak phase is greater than or equal to the phase threshold Th_{Ph,NA} of the NA sequence, then flag flag+b*c2*c0; and
if the ratio is less than or equal to the power threshold of the NACK sequence, i.e., Detₚ≤Th_{P}, then flag1=flag1+1; under the condition that flag is equal to an initial value, if an absolute value abs(Ph_{NACK}) of the peak phase is less than the phase threshold Th_{Ph,NA} of the NA sequence, then flag=b1*c2*c0; and if the absolute value abs(Ph_{NACK}) of the peak phase is greater than or equal to the phase threshold Th_{Ph,NA} of the NA sequence, then flag=b*c2*c0; and under the condition that flag is not equal to an initial value, if an absolute value abs(Ph_{NACK}) of the peak phase is less than the phase threshold Th_{Ph,NA} of the NA sequence, then flag=flag+b1*c2*c0; and if the absolute value abs(Ph_{NACK}) of the peak phase is greater than or equal to the phase threshold Th_{Ph,NA} of the NA sequence, then flag flag+b*c2*c0;
where b is a first preset value, b0 is a second preset value, b1 is a third preset value,

$$c 0 = \frac{{Det}_{P}}{{Th}_{P}} , c 1 = \frac{{Th}_{P , NA}}{{Det}_{P}} , c 2 = \frac{{Ph}_{NACK}}{{Th}_{Ph}} ,$$

Th_{P} is the power threshold of the NACK sequence, Th_{P,NA} is the power threshold of the NA sequence, Ph_{NACK} is the peak phase, Det_{P} is the ratio, and Th_{Ph} is the phase threshold of the NACK sequence.

In this implementation, the operation S308 may include operations S3081 and S3082.

At operation S3081, under the condition that higher-layer signaling indicates that the PSFCH signal is an NACK sequence or an NA sequence, determining that the PSFCH signal is the NACK sequence or the NA sequence based on the output state flag1 and the output weight flag.

At operation S3082, under the condition that higher-layer signaling indicates that the PSFCH signal is an NACK sequence or an ACK sequence, determining that the PSFCH signal is the NACK sequence or the ACK sequence based on the phase threshold Th_{Ph} of the NACK sequence and the output weight flag.

Further, the operation S3081 may include: determining a decision threshold thD based on the output state flag1, which includes, for example, determining whether the output state flag1 is equal to 2; under the condition that a determination result indicates that the output state is equal to 2, determining that the decision threshold thD is a fourth preset value th1; and under the condition that the determination result indicates that the output state is not equal to 2, determining that the decision threshold thD is a fifth preset value th2, where the fourth preset value th1 and the fifth preset value th2 are different preset values not equal to each other; determining whether the output weight flag is greater than the decision threshold thD; under the condition that a determination result indicates that the output weight is greater than the decision threshold, determining that the PSFCH signal is the NACK sequence; and under the condition that the determination result indicates that the output weight is not greater than the decision threshold, determining the PSFCH signal is the NA sequence.

Further, the operation S3082 may include: determining a decision threshold thD based on the phase threshold Th_{Ph} of the NACK sequence, which includes, for example, assigning a fourth preset value th1 to the phase threshold Th_{Ph} of the NACK sequence; determining that the decision threshold thD is a fourth preset value th1; determining whether the output weight flag is greater than the decision threshold thD; under the condition that a determination result indicates that the output weight is greater than the decision threshold, determining that the PSFCH signal is the NACK sequence; and under the condition that the determination result indicates that the output weight is not greater than the decision threshold, determining the PSFCH signal is the ACK sequence.

In one implementation, the PSFCH transmits a sequence at a transmitting port 5000 at a power factor β_{PSFCH}.

$$x ( n ) = {r}_{u , v}^{a , δ} ( n ) ;$$

$$n = 0 , 1 , … , {N}_{S C}^{R B} - 1 ;$$

$${r}_{u , v}^{( a , δ )} ( n ) = {e}^{jαn} {\overline{r}}_{u , v} ( n ) , 0 \leq n < {M}_{Z C} ,$$

$${\overline{r}}_{u , v} ( n ) = {e}^{j ϕ ( n ) π / 4} , 0 \leq n \leq {M}_{Z C} - 1 ; and$$

$${α}_{l} = \frac{2 π}{{N}_{SC}^{R B}} ( ( {m}_{0} + {m}_{C S} + {m}_{i n t} + {n}_{c s} ( {n}_{s , f}^{μ} , l + {l}^{′} ) ) mod {N}_{S C}^{R B} ) ;$$

where each of m₀, l, l′, u, v and mᵢₙₜ and the like can be obtained by signaling, while only m_{cs} used for calculating αᵢ is correlated with ACK/NACK, resulting in the ACK and NACK sequences x_{ACK}(n) and x_{NACK} (n), respectively.

The R16 NR protocol defines two PSFCH transmission methods: in a first method, for NACK sequence x_{NACK}(n), m_{cs}=0, and for ACK sequence x_{ACK}(n), m_{cs}=6, and since

$${N}_{SC}^{R B} = 12 ,$$

a difference of the NACK sequence and the ACK sequence is π; and in a second method, for NACK sequence x_{NACK} (n), m_{cs}=0, while the ACK sequence is not sent and marked as an NA sequence. A receiving UE acquires the current PSFCH transmission method through signaling.

The PSFCH is fixed on symbols l′-1 and l′ for transmission, where the same information is transmitted over the two symbols, the symbol l′−1 is used only for automatic gain control (AGC) at a receiving end, and the symbol l′ is used only for ACK/NACK information detection on the PSFCH.

Assume that the frequency domain PSFCH signal on the subcarrier m received via symbol l′ at port iRx is:

$$R ( i R x , m ) = \{ \begin{matrix}G ( iRx ) * ( H ( m ) * x ( m ) + {N}_{0} ( m ) ) , & with an ACK or NACK sequence \\ G ( iRx ) * {N}_{0} m , & \begin{matrix}no sequence transmitted , \\ marked as NA sequence .\end{matrix}\end{matrix}$$

In the above equation,

$$m = {n}_{0} + n ∈ \{ PSFCH \} n = 0 … , {N}_{S C}^{R B} - 1 ,$$

n₀ is a value determined by higher-layer signaling, G(iRx) is a gain at the receiving port iRx calculated through symbol l′−1, and N₀(m) is AWGN.

No matter which method is used for PSFCH transmission, the received signal is desired to be detected in a known sequence detection method, typically with the known NACK sequence x_{NACK}(n). One of the conventional methods for detecting the known NACK sequence x_{NACK}(n) involves using a method of local cross-correlation to improve an SNR of a detection cost function.

$${Ph}_{NACK} = \{ \begin{matrix}p , p < \frac{{N}_{IFFT}}{2} \\ {N}_{IFFT} - p , others\end{matrix} p = {PeakPos}_{k} \{ CIR ( k ) \} , k = 0 , 1 , … , {N}_{IFFT} - 1.$$

In the above equation,

$${PeakPos}_{k} \{ CIR ( k ) \}$$

prevents searching for a maximum value of CIR(k) within the range of k and outputting a corresponding k value.

$$CIR ( k ) = {Σ}_{iRx} {b}_{iRx} * {\vert {IFFT}_{{N}_{IFFT}} \{ R ( iRx , m ) * {x}_{NACK}^{*} ( m ) \vert}^{2} , k = 0 , 1 , … , {N}_{IFFT} - 1 , and m = 0 , 1 , … , {N}_{IFFT} - 1 ,$$

which is a cross-correlation result of the received frequency domain sequence

$$R ( iRx , m ) = \{ \begin{matrix}R ( iRx , m ) , m < {N}_{SC}^{R B} \\ 0 , others\end{matrix}$$

and the local known NACK sequence

$${x}_{NACK} ( m ) , where {b}_{i R x} = \{ \begin{matrix}1. , {iRx}_{minG} = {min}_{iRx} \{ G ( iRx ) \} \\ \frac{G ( {iRx}_{minG} )}{G ( iRx )} , others\end{matrix} ,$$

and N_{IFFT} is an integer of power N of 2 greater than or equal to

$${N}_{SC}^{R B} .$$

When the first PSFCH transmission method is adopted, i.e., when an ACK or NACK sequence is transmitted, detection of the ACK or NACK sequence is complemented by comparing Ph_{NACK} with a threshold.

$$Det = \{ \begin{matrix}NACK , 0 \underline{<} P {h}_{NACK} < T {h}_{P h} , \\ ACK , others\end{matrix} , {Th}_{P h} = \frac{{N}_{IFFT}}{{N}_{SC}^{R B}} * 6.$$

When the second PSFCH transmission method is adopted, i.e., when an NACK sequence is transmitted or no sequence is transmitted, it is still suitable after modifying the ACK sequence into the NA sequence based on the sequence detection result. However, when the SNR of the received signal is relatively low, this detection method may result in a relatively high probability of mistaking the transmitted NACK sequence as the NA sequence or the NA sequence as the NACK sequence due to high randomness of a CIR peak after correlation between a local sequence and a received AWGN, while in the conventional method, an absolute threshold of the CIR peak relative to a background noise is introduced to reduce the error detection probability, and therefore, a new cost function is introduced.

$${Det}_{P} = \frac{{P}_{NACK}}{{P}_{s e q}} ; \\ {P}_{NACK} = {PeakPower}_{k} \{ CIR ( k ) \} , k = 0 , 1 , … , {N}_{IFFT} - 1 ; \\ {P}_{s e q} = \frac{{\sum }_{k} CIR ( k ) - {P}_{NACK}}{{N}_{IFFT} - 1} .$$

In the above equations,

$${PeakPos}_{k} \{ CIR ( k ) \}$$

represents searching for and outputting a maximum value of the function CIR(k) within the range of k, P_{NACK} represents a peak power of the cross-correlation result CIR(k), P_{seq} represents a base power obtained by removing the peak power P_{NACK} from the cross-correlation result CIR(k). A new decision is introduced, which is expressed as:

$$Det = \{ \begin{matrix}NACK , 0 \underline{<} P {h}_{NACK} < T {h}_{P h} and {Det}_{p} > {Th}_{p} ; \\ NA , others\end{matrix} \\ {Th}_{P h} = \frac{{N}_{IFFT}}{{N}_{SC}^{R B}} * 6 , {Th}_{P = 4.}$$

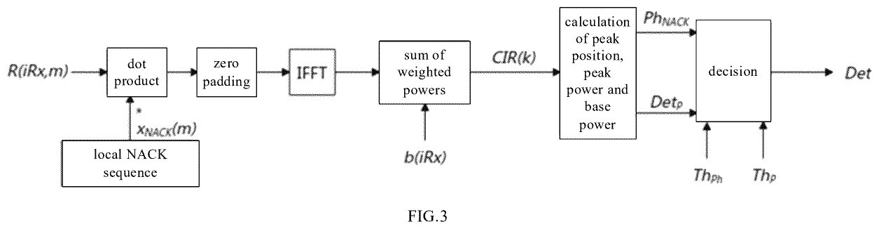

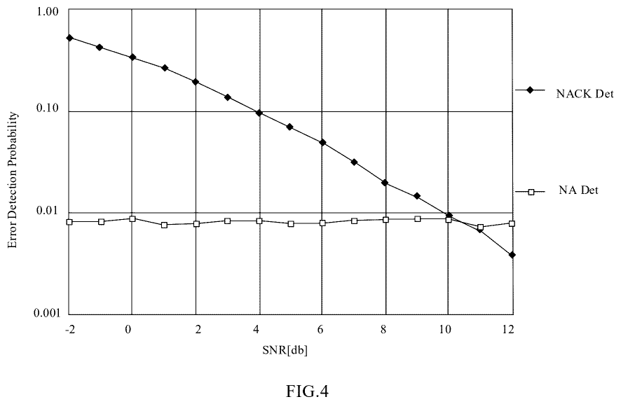

In the above equations, Th_{P}=4 is an empirical value. FIG. 3 is a schematic diagram of a PSFCH reception detection system in the existing art. As shown in FIG. 3, to reduce the error detection probabilities of both the NACK sequence and the NA sequence to less than 1%, two thresholds Th_{Ph} and Th_{P} in the new decision are desired to be adjusted, to obtain a simulation result of a next NR Sidelink typical channel under the thresholds. FIG. 4 is a schematic diagram of error detection performance verification for NACK and NA sequences in the existing art. As shown in FIG. 4, the performance still needs to be improved. As shown in FIG. 3, when the PSFCH detection system adopts the second PSFCH transmission method, i.e., when an NACK or NA sequence is transmitted, a root cause of the poor performance is that the randomness in both position and magnitude of the CIR peak of the AWGN sequence under a low SNR greatly interferes with the above decision.

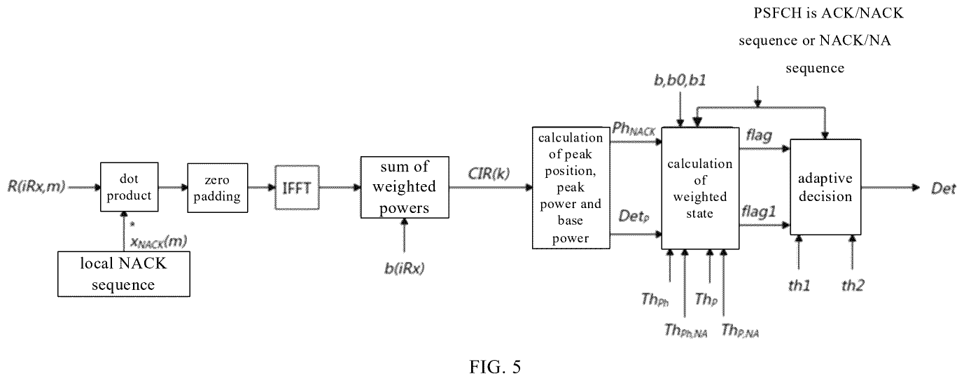

In view of the above problems, the present application enables an NR Sidelink receiving end to receive PSFCH well without notably increasing the complexity, and, in particular, provides greatly improved receiving detection performance when the PSFCH transmits the NACK/NA sequence. FIG. 5 is a schematic diagram of a PSFCH detection system according to the present application. As shown in FIG. 5, the detection process mainly includes: performing a dot product operation, zero padding, IFFT and summation of weighted powers on the received PSFCH signal and the local NACK sequence, to obtain a sum of weighted powers CIR(k), from which a peak phase, a peak power, and a base power are calculated through the above methods, which are not described in detail here.

The process further includes weighted state calculation, which may include: when the PSFCH transmission sequence is an ACK/NACK sequence: directly outputting a phase cost function output Ph_{NACK} to a weight, while outputting a state flag1.

The weighted state calculation may further include: when the PSFCH transmission sequence is a NACK/NA sequence: comparing the phase cost function output Ph_{NACK} and the power cost function output Det_{P} with a phase threshold Th_{Ph} and a power threshold Th_{P} corresponding to the NACK sequence, and a phase threshold Th_{Ph,NA} and a power threshold Th_{P,NA} corresponding to the NA sequence, respectively, to calculate the output weights flag of Ph_{NACK} and Det_{P} in one or two states, where the weights are calculated with different weight coefficients b, b0 and b1 in different states, and phase and power confidences in different states are introduced in the weight calculation, while outputting a state flag1.

The process further includes adaptive decision, which may include: when the PSFCH transmission sequence is an ACK or NACK sequence: comparing the output weight flag with th1, to obtain the determination that the currently received PSFCH signal is ACK or NACK; and when the PSFCH transmission sequence is a NACK or NA sequence: based on the output state flag1, selecting a fourth preset value th1 or a fifth preset value th2 as a threshold to be compared with the output weight flag, so as to obtain the determination that the currently received PSFCH signal is NACK or NA.

As shown in FIG. 5, the phase cost function output Ph_{NACK} and the power cost function output Det_{P} of the received PSFCH signal are obtained in the above methods, where Ph_{NACK} and Det_{P} are calculated in the same methods as those described above.

When the receiving end obtains a currently received PSFCH signal containing an NACK or NA sequence from the higher-layer signaling, outputs flag and flag1 are obtained in the weighted state calculation module by the operations of:
1, inputting a peak phase Ph_{NACK} and a ratio Det_{P}, a phase threshold Th_{Ph} and a power threshold Th_{P} corresponding to an NACK state, a phase threshold Th_{Ph,NA} and a power threshold Th_{P,NA} corresponding to an NA state, and weight coefficients b, b0 and b1;
2, resetting the output weight and the output state to: output weight flag=initial value; and output state flag1=0;
3, calculating phase and power confidences of the NACK state:

$$c 0 = \frac{{Det}_{P}}{{Th}_{P}} ; \\ c 2 = \frac{{Ph}_{NACK}}{{Th}_{P h}}$$

4, calculating a power confidence of the NA state:

$$c 1 = \frac{{Th}_{P , NA}}{{Det}_{P}}$$

5, calculating the output weight and setting the output state in a first method expressed as:

```
if fabs(Ph_{NACK}) ≥ Th_{Ph,NA}, or Det_{P} ≤ Th_{P,NA}
{
    if fabs(Ph_{NACK}) ≥ Th_{Ph,NA}
    {
        flag =-b*c2/c1;
    }
    else
    {
        flag1=1;
        flag =-b*c2*c1;
    }
}
```

6, calculating the output weight and setting the output state in a second method expressed as:

```
    if abs(Ph_{NACK}) < Th_{Ph}
{
    if Det_{P} > Th_{P}
    {
        if flag== initial value
        {
            if fabs(Ph_{NACK}) < Th_{Ph,NA}
                flag=b0*c2*c0;
            else
                flag=b*c2*c0;
            }
            else
            {
                if fabs(Ph_{NACK}) < Th_{Ph,NA}
                    flag=flag+b0*c2*c0;
                else
                    flag=flag+b*c2*c0;
            }
        }
        else
        {
            flag1=flag1+1;
            if flag== initial value
            {
                if fabs(Ph_{NACK}) < Th_{Ph,NA}
                    flag=b1*c2*c0;
                else
                    flag=b*c2*c0;
            }
            else
        {
            if fabs(Ph_{NACK}) < Th_{Ph,NA}
                flag=flag+b1*c2*c0;
            else
                flag=flag+b*c2*c0;
        }
    }
}
```

7, adaptive decision, including:
   when the receiving end obtains a currently received PSFCH signal containing an NACK or NA sequence from the higher-layer signaling, inputting the output weight flag, the output state flag1, the fourth preset value th1 and the fifth preset value th2 for adaptive decision, and obtaining a decision result Det by:

$$Det = \{ \begin{matrix}NACK , flag > thD \\ NA , others\end{matrix} , thD = \{ \begin{matrix}th 1 , flag 1 = 2 \\ th 2 , others\end{matrix} ,$$

when the receiving end obtains a currently received PSFCH signal containing an ACK or NACK sequence from the higher-layer signaling, as shown in FIG. 5, setting the output weight flag=Ph_{NACK} and the output state flag1=3 through calculation; and obtaining the decision result:

$$Det = \{ \begin{matrix}NACK , 0 \leq flag < thD \\ ACK , others\end{matrix} , thD = th 1 = {Th}_{Ph} .$$

In an NR Sidelink communication system, when the PSFCH signal is an NACK or NA sequence, using the PSFCH detection scheme shown in FIG. 5, and setting empirical values required for determining the output weight, the output state, and the decision result Det: N_{IFFT}=32, th1=1000, th2=100, b=1000, b0=2000, b1=4000,

$${Th}_{Ph , NA} = \frac{288 * {N}_{IFFT}}{4096}$$

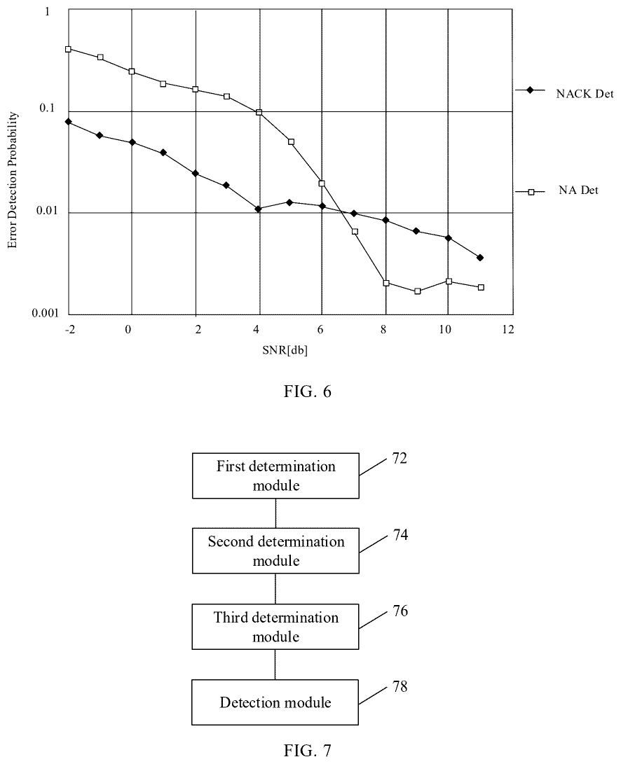

and Th_{P,NA}=5.5. FIG. 6 is schematic diagram of error detection performance verification for NACK and NA sequences according to the present application. As shown in FIG. 6, the SNR corresponding to an error detection probability =1% in the NACK and NA sequence is 6.7 dB. In contrast, the SNR corresponding to an error detection probability=1% in the NACK and NA sequence is 10 dB in the conventional detection method. As shown in FIG. 4, the SNR requirement in the new detection method is reduced by 3.3 dB compared with the method in the existing art.

The present application further provides a PSFCH signal detection device. FIG. 7 is a block diagram of a PSFCH signal detection device according to the present application. As shown in FIG. 7, the device includes: a first determination module 72 configured to determine a sum of weighted powers of a received PSFCH signal and a local NACK sequence; a second determination module 74 configured to determine a peak phase and a peak power based on the sum of weighted powers, determine a base power based on the sum of weighted powers and the peak power, and determine a ratio of the peak power to the base power; a third determination module 76 configured to determine an output weight of the PSFCH signal based on the peak phase and the ratio, and set an output state for the PSFCH signal; and a detection module 78 configured to detect the PSFCH signal based on the output weight and the output state.

In one implementation, the third determination module 76 includes: a first determination submodule configured to under the condition that higher-layer signaling indicates that the PSFCH signal is an NACK sequence or an NA sequence, determine the output weight of the PSFCH signal based on the peak phase, the ratio, a phase threshold of the NA sequence and a phase threshold of the NACK sequence, and set the output state for the PSFCH signal; and a second determination submodule configured to under the condition that higher-layer signaling indicates that the PSFCH signal is an NACK sequence or an ACK sequence, determine the output weight of the PSFCH signal based on the peak phase, the ratio, a power threshold of the NACK sequence, a power threshold of the NA sequence, and a phase threshold of the NACK sequence, and set the output state for the PSFCH signal.

In one implementation, the first determination submodule is further configured to initialize the output weight flag, and initialize the output state flag1 to 0;
under the condition that an absolute value of the peak phase is greater than or equal to the phase threshold of the NA sequence, i.e., abs(Ph_{NACK})≥Th_{Ph,NA}, determine the output weight flag by: flag=−b*c2/c1, while the output state flag remains unchanged; and
under the condition that the ratio is less than or equal to the power threshold of the NA sequence, i.e., Det_{P}≤Th_{P,NA}, set the output state flag1 to 1, and determine the output weight flag by: flag=−b*c2*c1;
where b is a first preset value,

$$c 1 = \frac{{Th}_{P , NA}}{{Det}_{P}} , c 2 = \frac{{Ph}_{NACK}}{{Th}_{P h}} ,$$

Th_{Ph,NA} is the phase threshold of the NA sequence, Th_{P,NA} is the power threshold of the NA sequence, Ph_{NACK} is the peak phase, Det_{P} is the ratio, and Th_{Ph} is the phase threshold of the NACK sequence.

In one implementation, the second determination submodule is further configured to, under the condition that an absolute value of the peak phase is less than the phase threshold of the NACK sequence, initialize the output weight flag, and initialize the output state flag1 to 0; and
keep the output state flag1 unchanged if the ratio is greater than the power threshold of the NACK sequence, i.e., Det_{P}>Th_{P}; where
under the condition that the output weight flag is equal to an initial value, if an absolute value of the peak phase is less than the phase threshold of the NA sequence, then flag=b0*c2*c0; and if the absolute value of the peak phase is greater than or equal to the phase threshold of the NA sequence, then flag=b*c2*c0;
under the condition that flag is not equal to an initial value, if an absolute value of the peak phase is less than the phase threshold of the NA sequence, then flag=flag+b0*c2*c0; and if the absolute value of the peak phase is greater than or equal to the phase threshold of the NA sequence, then flag=flag+b*c2*c0;
if the ratio is less than or equal to the power threshold of the NACK sequence, i.e., Det_{P}≤Th_{P}. then flag1=flag1+1;
under the condition that flag is equal to an initial value, if an absolute value of the peak phase is less than the phase threshold of the NA sequence, then flag=b1*c2*c0; and if the absolute value of the peak phase is greater than or equal to the phase threshold of the NA sequence, then flag=b*c2*c0; and
under the condition that flag is not equal to an initial value, if an absolute value of the peak phase is less than the phase threshold of the NA sequence, then flag=flag+b1*c2*c0; and if the absolute value of the peak phase is greater than or equal to the phase threshold of the NA sequence, then flag=flag+b*c2*c0;
where b is a first preset value, b0 is a second preset value, b1 is a third preset value,

$$c 0 = \frac{{Det}_{P}}{{Th}_{P}} , c 1 = \frac{{Th}_{P , NA}}{{Det}_{P}} , c 2 = \frac{{Ph}_{NACK}}{{Th}_{P h}} ,$$

Th_{P} is the power threshold of the NACK sequence, Th_{P,NA} is the power threshold of the NA sequence, Ph_{NACK} is the peak phase, Det_{P} is the ratio, and Th_{Ph} is the phase threshold of the NACK sequence.

In one implementation, the detection module 78 includes: a judgment submodule configured to under the condition that higher-layer signaling indicates that the PSFCH signal is an NACK sequence or an NA sequence, determine that the PSFCH signal is the NACK sequence or the NA sequence based on the output state flag1 and the output weight flag; and a determination submodule configured to under the condition that higher-layer signaling indicates that the PSFCH signal is an NACK sequence or an ACK sequence, determine that the PSFCH signal is the NACK sequence or the ACK sequence based on the phase threshold Th_{Ph} of the NACK sequence and the output weight flag.

In one implementation, the judgment submodule includes: a first determination unit configured to determine thD from the output state flag1; a first judgment unit configured to determine whether the output weight flag is greater than the decision threshold thD; a second determination unit configured to under the condition that a determination result indicates that the output weight is greater than the decision threshold, determine that the PSFCH signal is the NACK sequence; and under the condition that the determination result indicates that the output weight is not greater than the decision threshold, determine that the PSFCH signal is the NA sequence.

In one implementation, the first determination unit is further configured to determine whether the output state flag1 is equal to 2; under the condition that a determination result indicates that the output state is equal to 2, determine that the decision threshold thD is a fourth preset value th1; and under the condition that the determination result indicates that the output state is not equal to 2, determine that the decision threshold thD is a fifth preset value th2. The fourth preset value th1 and the fifth preset value th2 are different preset values not equal to each other.

In one implementation, the determination submodule includes: a third determination unit configured to determine a decision threshold thD based on the phase threshold Th_{Ph} of the NACK sequence; a second judgment unit configured to determine whether the output weight flag is greater than the decision threshold thD; a fourth determination unit configured to, under the condition that a determination result indicates that the output weight is greater than the decision threshold, determine that the PSFCH signal is the NACK sequence; and under the condition that the determination result indicates that the output weight is not greater than the decision threshold, determine that the PSFCH signal is the ACK sequence.

In one implementation, the third determination unit is further configured to assign a fourth preset value th1 to the phase threshold Th_{Ph} of the NACK sequence; and determine that the decision threshold thD is the fourth preset value th1.

In one implementation, the first determination module 72 is further configured to determine the sum of weighted powers of the received PSFCH signal and the local NACK sequence by:

$$CIR ( k ) = {\sum }_{iRx} {b}_{i R x} * {\vert {IFFT}_{{N}_{IFFT}} \{ R ( i Rx , m ) * {x}_{NACK}^{*} ( m ) \} \vert}^{2} ; \\ \\ {b}_{i R x} = \{ \begin{matrix}1. , {iRx}_{minG} = {min}_{iRx} \{ G ( iRx ) \} \\ \frac{G ( {iRx}_{minG} )}{G ( iRx )} , others\end{matrix} , {N}_{IFFT} \geq max ( 32 , {N}_{S C}^{R B} ) ;$$

where CIR(k) is the sum of weighted powers at a time point k, R(iRx, m) is a PSFCH signal received at a receiving port iRx on a subcarrier m,

$${x}_{NACK}^{*} ( m )$$

is a conjugate of the local NACK sequence on the subcarrier m, iRx_{minG} is a receiving port with the minimum gain, G(iRx) is a gain at the receiving port iRx determined through symbol l′−1, and

$${N}_{SC}^{R B}$$

iS a sixth preset value, k=0,1, . . . , N_{IFFT}−1, and m=0,1, . . . , N_{IFFT}−1.

In one implementation, the second determination module 74 is further configured to search for a position maximum value within a time point k range from the sum of weighted powers CIR(k), and determine the position maximum value as the peak phase, where

$$k = 0 , 1 , … , {N}_{IFFT} - 1 , {N}_{IFFT} \geq max ( 32 , {N}_{SC}^{RB} ) , and {N}_{SC}^{RB}$$

is a sixth preset value; search for a power maximum value within a time point k range from the sum of weighted powers CIR(k), and determine the power maximum value as the peak power; determine the base power based on the sum of weighted powers and the peak power by:

$${P}_{seq} = \frac{{\sum }_{k} CIR ( k ) - {P}_{NACK}}{{N}_{IFFT} - 1} ;$$

and
determine the ratio of the peak power to the base power by:

$${Det}_{P} = \frac{{P}_{NACK}}{{P}_{seq}} ,$$

where CIR(k) is the sum of weighted powers, Ph_{NACK} is the peak phase, P_{NACK} is the peak power, P_{seq} is the base power, and Det_{P} is the ratio.

The present application further provides a computer-readable storage medium having a computer program stored thereon, where the computer program, when executed by a processor, causes the processor to implement operations of any method described above.

In an exemplary implementation, the computer-readable storage medium may include, but is not limited to: a U disk, a read-only memory (ROM), a random access memory (RAM), a mobile hard disk, a magnetic or optical disk, or any other medium that can store computer programs.

The present application further provides an electronic device, including a memory and a processor, where the memory has a computer program stored thereon, and the processor is configured to execute the computer program to implement operations of any method as described above.

In an exemplary implementation, the electronic device may further include a transmission device and an input/output device. The transmission device is connected to the processor, and the input/output device is connected to the processor.

For examples of the device implementation, reference may be made to the examples described in the above and exemplary implementations, which are not repeated here.

According to the present application, by determining a sum of weighted powers of a received PSFCH signal and a local NACK sequence; determining a peak phase and a peak power based on the sum of weighted powers, determining a base power based on the sum of weighted powers and the peak power, and determining a ratio of the peak power to the base power; determining an output weight of the PSFCH signal based on the peak phase and the ratio, and setting an output state; and detecting the PSFCH signal based on the output weight and the output state, the problem of the high error detection probability of the PSFCH signal in the case of a relatively low SNR of the received signal in the existing art can be solved, and by detecting the received PSFCH signal based on the output weight and output state determined from the peak phase and the ratio, the error detection probability of the PSFCH signal is reduced.

Obviously, a person skilled in the art will understand that the above modules and operations of the present application may be implemented by a universal computing device, may be integrated in a single computing device or distributed over a network that consists of a plurality of computing devices. They can be implemented by executable program codes of the computing device so that they can be stored in a storage device and executed by the computing device, and, in some cases, the shown or described operations may be performed out of the order shown herein, or they may be made into different integrated circuit modules respectively, or a plurality of modules or operations therein may be made into a single integrated circuit module to be implemented. In this way, the present application is not restricted to any particular hardware and software combination.

The above are merely exemplary implementations of the present application, which are not intended to restrict the present disclosure. For those skilled in the art, the present application may have various changes and variations. Any amendments, equivalent substitutions, improvements, etc. within the principle of the present application are included in the scope of protection defined by the appended claims of the present application.

1. A physical sidelink feedback channel (PSFCH) signal detection method, comprising:
determining a sum of weighted powers of a received PSFCH signal and a local NACK sequence;
determining a peak phase and a peak power based on the sum of weighted powers, determining a base power based on the sum of weighted powers and the peak power, and determining a ratio of the peak power to the base power;
determining an output weight of the PSFCH signal based on the peak phase and the ratio, and setting an output state for the PSFCH signal; and
detecting the PSFCH signal based on the output weight and the output state.

2. The method according to claim 1, wherein the operation of determining the output weight of the PSFCH signal based on the peak phase and the ratio, and setting the output state for the PSFCH signal comprises:
under a condition that higher-layer signaling indicates that the PSFCH signal is an NACK sequence or an NA sequence, determining the output weight based on the peak phase, the ratio, a phase threshold of the NA sequence and a phase threshold of the NACK sequence, and setting the output state for the PSFCH signal; and
under a condition that higher-layer signaling indicates that the PSFCH signal is an NACK sequence or an ACK sequence, determining the output weight of the PSFCH signal based on the peak phase, the ratio, a power threshold of the NACK sequence, a power threshold of the NA sequence, and a phase threshold of the NACK sequence, and setting the output state for the PSFCH signal.

3. The method according to claim 2, wherein the operation of determining the output weight based on the peak phase, the ratio, the phase threshold of the NA sequence and the phase threshold of the NACK sequence, and setting the output state for the PSFCH signal comprises:
initializing the output weight flag, and initializing the output state flag1 to 0;
under a condition that an absolute value of the peak phase is greater than or equal to the phase threshold of the NA sequence, determining the output weight flag by: flag=−b*c2/c1, while the output state flag1 remains unchanged; and
under a condition that the ratio is less than or equal to the power threshold of the NA sequence, setting the output state flag1 to 1, and determining the output weight flag by: flag=−b*c2*c1;
wherein b is a first preset value,
$$c 1 = \frac{{Th}_{P , NA}}{{Det}_{P}} , c 2 = \frac{{Ph}_{NACK}}{{Th}_{Ph}} ,$$
Th_{Ph,NA} is the phase threshold of the NA sequence, Th_{P,NA} is the power threshold of the NA sequence, Ph_{NACK} is the peak phase, Det_{P} is the ratio, and Th_{Ph} is the phase threshold of the NACK sequence.

4. The method according to claim 2, wherein the operation of determining the output weight of the PSFCH signal based on the peak phase, the ratio, a power threshold of the NACK sequence, the power threshold of the NA sequence, and the phase threshold of the NACK sequence, and setting the output state for the PSFCH signal comprises:
under a condition that an absolute value of the peak phase is less than the phase threshold of the NACK sequence, initializing the output weight flag, and initializing the output state flag1 to 0; and
keeping the output state flag1 unchanged if the ratio is greater than the power threshold of the NACK sequence; wherein
under a condition that the output weight flag is equal to an initial value, if an absolute value of the peak phase is less than the phase threshold of the NA sequence, then flag=b0*c2*c0; and if the absolute value of the peak phase is greater than or equal to the phase threshold of the NA sequence, then flag=b*c2*c0;
under a condition that the output weight flag is not equal to an initial value, if an absolute value of the peak phase is less than the phase threshold of the NA sequence, then flag flag+b0*c2*c0; and if the absolute value of the peak phase is greater than or equal to the phase threshold of the NA sequence, then flag=flag+b*c2*c0;
if the ratio is less than or equal to the power threshold of the NACK sequence, then flag1−flag1+1;
under a condition that the output weight flag is equal to an initial value, if an absolute value of the peak phase is less than the phase threshold of the NA sequence, then flag=b1*c2*c0; and if the absolute value of the peak phase is greater than or equal to the phase threshold of the NA sequence, then flag=b*c2*c0; and
under a condition that the output weight flag is not equal to an initial value, if an absolute value of the peak phase is less than the phase threshold of the NA sequence, then flag=flag+b1*c2*c0; and if the absolute value of the peak phase is greater than or equal to the phase threshold of the NA sequence, then flag=flag+b*c2*c0;
wherein b is a first preset value, b0 is a second preset value, b1 is a third preset value,
$$c 0 = \frac{{Det}_{P}}{{Th}_{P}} , c 1 = \frac{{Th}_{P , NA}}{{Det}_{P}} , c 2 = \frac{{Ph}_{NACK}}{{Th}_{Ph}} ,$$
Th_{P} is the power threshold of the NACK sequence, Th_{P,NA} is the power threshold of the NA sequence, Ph_{NACK} is the peak phase, Det_{P} is the ratio, and Th_{Ph} is the phase threshold of the NACK sequence.

5. The method according to claim 1, wherein the operation of detecting the PSFCH signal based on the output weight and the output state comprises:
under a condition that higher-layer signaling indicates that the PSFCH signal is an NACK sequence or an NA sequence, determining that the PSFCH signal is the NACK sequence or the NA sequence based on the output state flag1 and the output weight flag; and
under a condition that higher-layer signaling indicates that the PSFCH signal is an NACK sequence or an ACK sequence, determining that the PSFCH signal is the NACK sequence or the ACK sequence based on the phase threshold Th_{Ph} of the NACK sequence and the output weight flag.

6. The method according to claim 5, wherein the operation of determining that the PSFCH signal is the NACK sequence or the NA sequence based on the output state flag1 and the output weight flag comprises:
determining a decision threshold thD based on the output state flag1;
determining whether the output weight flag is greater than the decision threshold thD;
under a condition that a determination result indicates that the output weight is greater than the decision threshold, determining that the PSFCH signal is the NACK sequence; and
under a condition that the determination result indicates that the output weight is not greater than the decision threshold, determining that the PSFCH signal is the NA sequence.

7. The method according to claim 6, wherein the operation of determining the decision threshold thD based on the output state flag1 comprises:
determining whether the output state flag1 is equal to 2;
under a condition that a determination result indicates that the output state is equal to 2, determining that the decision threshold thD is a fourth preset value th1; and
under a condition that the determination result indicates that the output state is not equal to 2, determining that the decision threshold thD is a fifth preset value th2, wherein the fourth preset value th is not equal to the fifth preset value th2.

8. The method according to claim 5, wherein the operation of determining that the PSFCH signal is the NACK sequence or the ACK sequence based on the phase threshold Th_{Ph} of the NACK sequence and the output weight flag comprises:
determining a decision threshold thD based on the phase threshold Th_{Ph} of the NACK sequence;
determining whether the output weight flag is greater than the decision threshold thD;
under a condition that a determination result indicates that the output weight is greater than the decision threshold, determining that the PSFCH signal is the NACK sequence; and
under a condition that the determination result indicates that the output weight is not greater than the decision threshold, determining that the PSFCH signal is the ACK sequence.

9. The method according to claim 8, wherein the operation of determining the decision threshold thD based on the phase threshold Th_{Ph} of the NACK sequence comprises:
assigning a fourth preset value th1 to the phase threshold of the NACK sequence Th_{Ph}; and
determining that the decision threshold thD is the fourth preset value th1.

10. The method according to claim 1, wherein the method further comprises:
determining the sum of weighted powers of the received PSFCH signal and the local NACK sequence by:
$$CIR ( k ) = {\sum }_{iRx} {b}_{iRx} * {\vert {IFFT}_{{N}_{IFFT}} \{ R ( iRx , m ) * {x}_{NACK}^{*} ( m ) \} \vert}^{2} ;$$
$${b}_{iRx} = \{ \begin{matrix}1. , {iRx}_{minG} = {min}_{iRx} \{ G ( iRx ) \} \\ \frac{G ( {iRx}_{minG} )}{G ( iRx )} , others\end{matrix} , {N}_{IFFT} \geq max ( 32 , {N}_{SC}^{RB} ) ;$$
wherein CIR(k) is the sum of weighted powers at a time point k, R(iRx, m) is a PSFCH signal received at a receiving port iRx on a subcarrier m,
$${x}_{NACK}^{*} ( m )$$
is a conjugate of the local NACK sequence on the subcarrier m, iRx_{minG} is a receiving port with the minimum gain, G(iRx) is a gain determined at the receiving port iRx, and
$${N}_{SC}^{RB}$$
is a sixth preset value, k=0,1, . . . , N_{IFFT}−1, and m=0,1, . . . , N_{IFFT}−1.

11. The method according to claim 1, wherein the operation of determining the peak phase and the peak power based on the sum of weighted powers, determining the base power based on the sum of weighted powers and the peak power, and determining the ratio of the peak power to the base power comprises:
searching for a position maximum value within a time point k range, from the sum of weighted powers CIR(k), and determining the position maximum value as the peak phase, wherein
$$k = 0 , 1 , … , {N}_{IFFT} - 1 , {N}_{IFFT} \geq max ( 32 , {N}_{SC}^{RB} ) , and {N}_{SC}^{RB}$$
is a sixth preset value;
searching for a power maximum value within the time point k range from the sum of weighted powers CIR(k), and determining the power maximum value as the peak power;
determining the base power based on the sum of weighted powers and the peak power by:
$${P}_{seq} = \frac{{\sum }_{k} CIR ( k ) - {P}_{NACK}}{{N}_{IFFT} - 1} ;$$
and
determining the ratio of the peak power to the base power by:
$${Det}_{P} = \frac{{P}_{NACK}}{{P}_{seq}} ;$$
wherein P_{NACK} is the peak power, P_{seq} is the base power, and Det_{P} is the ratio.

12. A physical sidelink feedback channel (PSFCH) signal detection device, comprising a processor and a storage having instructions stored thereon which, when being executed by the processor, cause the processor to:
determine a sum of weighted powers of a received PSFCH signal and a local NACK sequence;
determine a peak phase and a peak power based on the sum of weighted powers, determine a base power based on the sum of weighted powers and the peak power, and determine a ratio of the peak power to the base power;
determine an output weight of the PSFCH signal based on the peak phase and the ratio, and set an output state for the PSFCH signal; and
detect the PSFCH signal based on the output weight and the output state.

13. A non-transitory computer-readable storage medium having a computer program stored thereon, wherein the computer program, when executed by a processor, causes the processor to implement the method according to claim 1.

14. An electronic device, comprising a memory and a processor, wherein the memory has a computer program stored thereon, and the processor is configured to execute the computer program to:
determine a sum of weighted powers of a received PSFCH signal and a local NACK sequence;
determine a peak phase and a peak power based on the sum of weighted powers, determine a base power based on the sum of weighted powers and the peak power, and determine a ratio of the peak power to the base power;
determine an output weight of the PSFCH signal based on the peak phase and the ratio, and set an output state for the PSFCH signal; and
detect the PSFCH signal based on the output weight and the output state.

15. The method according to claim 2, wherein the method further comprises:
determining the sum of weighted powers of the received PSFCH signal and the local NACK sequence by:
$$CIR ( k ) = {\sum }_{iRx} {b}_{iRx} * {\vert {IFFT}_{{N}_{IFFT}} \{ R ( iRx , m ) * {x}_{NACK}^{*} ( m ) \} \vert}^{2} ;$$
$${b}_{iRx} = \{ \begin{matrix}1. , {iRx}_{minG} = {min}_{iRx} \{ G ( iRx ) \} \\ \frac{G ( {iRx}_{minG} )}{G ( iRx )} , others\end{matrix} , {N}_{IFFT} \geq max ( 32 , {N}_{SC}^{RB} ) ;$$
wherein CIR(k) is the sum of weighted powers at a time point k, R(iRx, m) is a PSFCH signal received at a receiving port iRx on a subcarrier m,
$${x}_{NACK}^{*} ( m )$$
is a conjugate of the local NACK sequence on the subcarrier m, iRx_{minG} is a receiving port with the minimum gain, G(iRx) is a gain determined at the receiving port iRx, and
$${N}_{SC}^{RB}$$
is a sixth preset value, k=0,1, . . . , N_{IFFT}−1, and m=0,1, . . . , N_{IFFT}−1.

16. The method according to claim 5, wherein the method further comprises:
determining the sum of weighted powers of the received PSFCH signal and the local NACK sequence by:
$$CIR ( k ) = {\sum }_{iRx} {b}_{iRx} * {\vert {IFFT}_{{N}_{IFFT}} \{ R ( iRx , m ) * {x}_{NACK}^{*} ( m ) \} \vert}^{2} ;$$
$${b}_{iRx} = \{ \begin{matrix}1. , & {iRx}_{minG} = {min}_{iRx} \{ G ( iRx ) \} \\ \frac{G ( {iRx}_{minG} )}{G ( iRx )} , & others\end{matrix} , {N}_{IFFT} \geq max ( 32 , {N}_{SC}^{RB} ) ;$$
wherein CIR(k) is the sum of weighted powers at a time point k, R(iRx, m) is a PSFCH signal received at a receiving port iRx on a subcarrier m,
$${x}_{NACK}^{*} ( m )$$
is a conjugate of the local NACK sequence on the subcarrier m, iRx_{minG} is a receiving port with the minimum gain, G(iRx) is a gain determined at the receiving port iRx, and
$${N}_{SC}^{RB}$$
is a sixth preset value, k=0,1, . . . , N_{IFFT}−1, and m=0,1, . . . , N_{IFFT}−1.

17. The method according to claim 6, wherein the method further comprises:
determining the sum of weighted powers of the received PSFCH signal and the local NACK sequence by:
$$CIR ( k ) = {\sum }_{iRx} {b}_{iRx} * {\vert {IFFT}_{{N}_{IFFT}} \{ R ( iRx , m ) * {x}_{NACK}^{*} ( m ) \} \vert}^{2} ;$$
$${b}_{iRx} = \{ \begin{matrix}1. , & {iRx}_{minG} = {min}_{iRx} \{ G ( iRx ) \} \\ \frac{G ( {iRx}_{minG} )}{G ( iRx )} , & others\end{matrix} , {N}_{IFFT} \geq max ( 32 , {N}_{SC}^{RB} ) ;$$
wherein CIR(k) is the sum of weighted powers at a time point k, R(iRx, m) is a PSFCH signal received at a receiving port iRx on a subcarrier m,
$${x}_{NACK}^{*} ( m )$$
is a conjugate of the local NACK sequence on the subcarrier m, iRx_{minG} is a receiving port with the minimum gain, G(iRx) is a gain determined at the receiving port iRx, and
$${N}_{SC}^{RB}$$
is a sixth preset value, k=0,1, . . . , N_{IFFT}−1, and m=0,1, . . . , N_{IFFT}−1.

18. The method according to claim 2, wherein the operation of determining the peak phase and the peak power based on the sum of weighted powers, determining the base power based on the sum of weighted powers and the peak power, and determining the ratio of the peak power to the base power comprises:
searching for a position maximum value within a time point k range, from the sum of weighted powers CIR(k), and determining the position maximum value as the peak phase, wherein
$$k = 0 , 1 , … , {N}_{IFFT} - 1 , {N}_{IFFT} \geq max ( 32 , {N}_{SC}^{RB} ) , and {N}_{SC}^{RB}$$
is a sixth preset value;
searching for a power maximum value within the time point k range from the sum of weighted powers CIR(k), and determining the power maximum value as the peak power;
determining the base power based on the sum of weighted powers and the peak power by:
$${P}_{seq} = \frac{{\sum }_{k} CIR ( k ) - {P}_{NACK}}{{N}_{IFFT} - 1} ;$$
and
determining the ratio of the peak power to the base power by:
$${Det}_{P} = \frac{{P}_{NACK}}{{P}_{seq}} ;$$
wherein P_{NACK} is the peak power, P_{seq} is the base power, and Det_{P} is the ratio.

19. The method according to claim 5, wherein the operation of determining the peak phase and the peak power based on the sum of weighted powers, determining the base power based on the sum of weighted powers and the peak power, and determining the ratio of the peak power to the base power comprises:
searching for a position maximum value within a time point k range, from the sum of weighted powers CIR(k), and determining the position maximum value as the peak phase, wherein
$$k = 0 , 1 , … , {N}_{IFFT} - 1 , {N}_{IFFT} \geq max ( 32 , {N}_{SC}^{RB} ) , and {N}_{SC}^{RB}$$
is a sixth preset value;
searching for a power maximum value within the time point k range from the sum of weighted powers CIR(k), and determining the power maximum value as the peak power;
determining the base power based on the sum of weighted powers and the peak power by:
$${P}_{seq} = \frac{{\sum }_{k} CIR ( k ) - {P}_{NACK}}{{N}_{IFFT} - 1} ;$$
and
determining the ratio of the peak power to the base power by:
$${Det}_{P} = \frac{{P}_{NACK}}{{P}_{seq}} ;$$
wherein P_{NACK} is the peak power, P_{seq} is the base power, and Det_{P} is the ratio.

20. The method according to claim 6, wherein the operation of determining the peak phase and the peak power based on the sum of weighted powers, determining the base power based on the sum of weighted powers and the peak power, and determining the ratio of the peak power to the base power comprises:
searching for a position maximum value within a time point k range, from the sum of weighted powers CIR(k), and determining the position maximum value as the peak phase, wherein
$$k = 0 , 1 , … , {N}_{IFFT} - 1 , {N}_{IFFT} \geq max ( 32 , {N}_{SC}^{RB} ) , and {N}_{SC}^{RB}$$
is a sixth preset value;
searching for a power maximum value within the time point k range from the sum of weighted powers CIR(k), and determining the power maximum value as the peak power;
determining the base power based on the sum of weighted powers and the peak power by:
$${P}_{seq} = \frac{{\sum }_{k} CIR ( k ) - {P}_{NACK}}{{N}_{IFFT} - 1} ;$$
and
determining the ratio of the peak power to the base power by:
$${Det}_{P} = \frac{{P}_{NACK}}{{P}_{seq}} ;$$
wherein P_{NACK} is the peak power, P_{seq} is the base power, and Det_{P} is the ratio.
